(19) United States
(12) Patent Application Publication
(10) Pub. No.: US 2014/0274867 A1
(43) Pub. Date: Sep. 18, 2014

(54) CLEANSING BARS COMPRISING SUPERHYDROPHILIC AMPHIPHILIC COPOLYMERS AND METHODS OF USE THEREOF

(71) Applicant: JOHNSON & JOHNSON CONSUMER COMPANIES, INC., Skillman, NJ (US)

(72) Inventors: Elizabeth Bruning, Somerset, NJ (US); Michael J. Fevola, Belle Mead, NJ (US); Edmund Donald George, South Kingstown, RI (US); Euen T. Ekman-Gunn, Trenton, NJ (US); David Joseph Raymond, Greene, RI (US); Frank C. Sun, Branchburt, NJ (US)

(73) Assignee: JOHNSON & JOHNSON CONSUMER COMPANIES, INC., Skillman, NJ (US)

(21) Appl. No.: 13/804,211

(22) Filed: Mar. 14, 2013

(51) Int. Cl. C11D 3/22

(52) U.S. Cl. CPC C11D 3/222
USPC 510/447

(57) ABSTRACT

Provided are low-irritation, high foaming personal care compositions comprising superhydrophilic amphiphilic copolymers. Also provided are methods of making and using such compositions.

### FIELD OF INVENTION

The present invention relates to cleansing bars comprising superhydrophilic amphiphilic copolymers and, in particular, high foaming, mild cleansing bars comprising superhydrophilic amphiphilic copolymers.

### DESCRIPTION OF THE RELATED ART

Cleansing bars are well-known for providing a cost-effective and convenient means for washing the skin. Typical cleansing bars include soap and/or synthetic surfactants and various other ingredients to provide functional and aesthetically appealing cleansing experience.

One approach for providing cleansing bars with good lathering, is exemplified in U.S. Pat. No. 5,372,751 (Rys-Cicciari et al.) and relates to the use of particular combinations of surfactants. Applicants have however recognized the need for entirely new cleansing bar compositions that provide more enhancement of foaming while maintaining reduced irritation, and/or ease of manufacture.

### SUMMARY OF THE INVENTION

The present invention provides cleansing compositions that overcome the disadvantages of the prior art and have relatively high foaming associated therewith. In particular, applicants have discovered that superhydrophilic amphiphilic copolymers may be used to great advantage to produce cleansing bars having high foaming and low irritation associated therewith.

According to one aspect, the present invention provides a cleansing bar that comprises a non-soap anionic surfactant, a superhydrophilic amphiphilic copolymer, a hydrophobic binder, and a water-soluble bar hardener. The cleansing bar has a pH of about 8 or less.

In another aspect of the invention, applicants have provided a method of treating the skin, hair, or vaginal region, the method comprising applying to the skin, hair, or vaginal region a cleansing bar that comprises a non-soap anionic surfactant, a superhydrophilic amphiphilic copolymer, a hydrophobic binder; and a water-soluble bar hardener. The cleansing bar has a pH of about 8 or less.

In yet another aspect of the invention, applicants have provided a method of making a cleansing bar, the method comprising heating an aqueous surfactant mixture to render it fluid wherein the aqueous surfactant mixture comprises a hydrophobic binder, a non-soap anionic surfactant, a water soluble bar hardener, and from about 0.25 percent to about 20 percent water. The method further comprises adding a solid superhydrophilic amphiphilic copolymer to the heated aqueous surfactant mixture to form a surfactant/copolymer blend; extruding the surfactant/copolymer blend to form an extruded surfactant mass, and forming a solid cleansing bar having a pH of about 8 or less.

### BRIEF DESCRIPTION OF THE DRAWINGS

FIG. 1 is a graphical depiction of the results of the Cleansing Bar Foam Test for certain compositions of the present invention and comparable compositions.

FIG. 2 is a graphical depiction of the results of the Cleansing Bar Foam Test for another composition of the present invention and a comparable composition.

### DESCRIPTION OF PREFERRED EMBODIMENTS

We have discovered that the cleansing bars of the invention exhibit a unique and unexpected combination of properties including high lathering characteristics and relatively low irritation and ease of manufacturability. This makes the cleansing bars compositions of this invention highly desirable for skincare, including baby and infant skin, cosmetic or cleansing compositions. The cleansing bars of this invention comprise a non-soap anionic surfactant, a hydrophobic binder, a water-soluble bar hardener and further comprise a superhydrophilic amphiphilic copolymer and have a pH less than about 8. Surprisingly, incorporation of the superhydrophilic amphiphilic copolymer into these relatively low pH cleansing bars results in a mild cleansing bar composition that is easily processed and better lathering than previously thought would be possible. All percentages listed in this specification are percentages by weight, unless otherwise specifically mentioned.

As used herein, the term “pH” shall include pH measurements as determined by ASTM method E70-07 Standard Test Method for pH of Aqueous Solutions with the Glass Electrode.

As used herein, the term “cleansing bar” refers to a cleansing composition in the form of a bar, i.e., a solid (maintaining its shape rather than taking the shape of its container) under ambient conditions. The bar may be of varying shapes and cross-sections, e.g., circular, oval, square, rectangular; flat or rounded; or non-conventional shapes. Desirably, the bar is suitable to hold in one's hand(s). As such, the cleansing bar may have dimensions such that the length or longest dimension is from about 4 cm to about 12 cm, preferably from about 5 cm to about 10 cm; the width is from about 3 cm to about 8 cm, preferably from about 4 cm to about 7 cm; and a thickness from about 0.25 cm to about 4 cm, preferably from about 0.5 cm to about 3 cm.

Upon being wet, cleansing bars release or exude a cleansing composition that have the ability to remove dirt, oils, excess sebum and the like from the skin surface and which produce a foam (i.e., a frothy mass of fine bubbles formed in or on the surface of a liquid or from a liquid). The cleansing bar is typically wet with water and applied to the skin. Rubbing the cleansing bar with one's fingers or hands, a wash cloth, or other implement, e.g. a pouf, may result in sudsing or foaming of the cleansing composition to produce a lather. The composition is then rinsed off with water.

Cleansing bars of the present invention may be used in typical personal care cleansing—on adult or infant skin that is intact or skin that has for example a wound or perturbed barrier. Various parts of the body may be cleansed, for example, face, body, hair, internal or external vaginal area and the like.

### Non-Soap Anionic Surfactant

As used herein “anionic surfactant” refers to an amphiphilic molecule comprising a hydrophobic group and one or more hydrophilic groups comprising a negatively charged moiety or a moiety capable of bearing a negative charge (in the latter case, for example, as a function of acid-base properties and solution pH). As used herein “non soap anionic surfactant” refers to an anionic surfactant other than the following: alkali (e.g. Na⁺ and K⁺), alkaline earth (e.g. Mg²⁺ and Ca²⁺), ammonium, or triethanolamine salts of saturated and unsaturated C₆-C₂₄ fatty acids, i.e. alkyl monocarboxylate salts. As one skilled in the art will recognize, soaps are most often derived from the saponification of triglycerides.

Examples of suitable non-soap anionic surfactants include the following:
Acyl isethionates

[chemical structure]

Where RCO═C₈-C₂₀ acyl (linear or branched, saturated or unsaturated) or mixtures thereof, R′═H or CH₃, M⁺=monovalent cation, such as Sodium Cocoyl Isethionate (RCO=coco acyl, R′═H, M⁺=Na⁺) and Sodium Lauroyl Methyl Isethionate (RCO=lauroyl, R′═CH₃, M⁺=Na⁺);
Alkyl sulfosuccinates

[chemical structure]

Where R═C₈-C₂₀ alkyl (linear or branched, saturated or unsaturated) or mixtures thereof and M⁺=monovalent cation, such as Disodium Lauryl Sulfosuccinate (R=lauryl, M⁺=Na⁺);
α-Sulfo fatty acid esters

[chemical structure]

Where R═C₆-C₁₆ alkyl (linear or branched, saturated or unsaturated) or mixtures thereof, R′═C₁-C₂ alkyl, and M⁺=monovalent cation, such as Sodium Methyl 2-Sulfolaurate (R═C₁₀H₂₁, R′=methyl, CH₃, and M⁺=Na⁺);
α-Sulfo fatty acid salts

[chemical structure]

Where R═C₆-C₁₆ alkyl (linear or branched, saturated or unsaturated) or mixtures thereof, M⁺=monovalent cation, such as Disodium 2-Sulfolaurate (R═C₁₀H₂₁, M⁺=Na⁺);
Alkyl Sulfoacetates

[chemical structure]

Where R═C₆-C₁₈ alkyl (linear or branched, saturated or unsaturated) or mixtures thereof, M⁺=monovalent cation, such as Sodium Lauryl Sulfoacetate (R=lauryl, C₁₂H₂₅, M⁺=Na⁺);
Alkyl sulfates

[chemical structure]

where R═C₈-C₂₀ alkyl (linear or branched, saturated or unsaturated) or mixtures thereof. Specific examples include TEA-Lauryl Sulfate (R=lauryl, C₁₂H₂₅, M⁺=⁺HN(CH₂CH₂OH)₃), Sodium Lauryl Sulfate (R=lauryl, C₁₂H₂₅, M⁺=Na⁺), and Sodium Coco-Sulfate (R=coco alkyl, M⁺=Na⁺);
Alkyl glyceryl ether sulfonates or alkoxyl hydroxypropyl sulfonates:

[chemical structure]

where R═C₈-C₂₄ alkyl (linear or branched, saturated or unsaturated) or mixtures thereof and M⁺=monovalent cation, such as Sodium Cocoglyceryl Ether Sulfonate (R=coco alkyl, M⁺=Na⁺);
α-olefin sulfonates prepared by sulfonation of long chain alpha olefins. Alpha olefin sulfonates consist of mixtures of alkene sulfonates,

[chemical structure]

where R═C₄-C₁₈ alkyl or mixtures thereof and M⁺=monovalent cation, and hydroxyalkyl sulfonates,

[chemical structure]

where R═C₄-C₁₈ alkyl or mixtures thereof and M⁺=monovalent cation. Examples include Sodium C12-14 Olefin Sulfonate (R═C₈-C₁₀ alkyl, M⁺=Na⁺) and Sodium C14-16 Olefin Sulfonate (R═C₁₀-C₁₂ alkyl, M⁺=Na⁺);
Alkyl sulfonates or paraffin sulfonates:

[chemical structure]

where R═C₈-C₂₄ alkyl (linear or branched, saturated or unsaturated) or mixtures thereof and M⁺=monovalent cation. Examples include Sodium C13-17 Alkane Sulfonate (R═C₁₃-C₁₇ alkyl, M⁺=Na⁺) and Sodium C14-17 Alkyl Sec Sulfonate (R═C₁₄-C₁₇ alkyl, M⁺=Na⁺);
Alkylaryl sulfonates or linear alkyl benzene sulfonates

[chemical structure]

where R═C₆-C₁₈ alkyl (linear, saturated or unsaturated) or mixtures thereof and M⁺=monovalent cation. Examples include Sodium Deceylbenzenesulfonate (R═C₁₀ alkyl, M⁺=Na⁺) and Ammonium Dodecylbenzensulfonate (R═C₁₂ alkyl, M⁺=NH₄⁺);
Alkyl ether sulfates

[chemical structure]

where R═C₈-C₂₄ alkyl (linear or branched, saturated or unsaturated) or mixtures thereof, n=1-12, and M⁺=monovalent cation. Examples include Sodium Laureth Sulfate (R═C₁₂ alkyl, M⁺=Na⁺, n=1-3), Ammonium Laureth Sulfate (R═C₁₂ alkyl, M⁺=NH₄⁺, n=1-3), and Sodium Trideceth Sulfate (R═C₁₃ alkyl, M⁺=Na⁺, n=1-4);
Alkyl monoglyceride sulfates

[chemical structure]

where RCO═C₈-C₂₄ acyl (linear or branched, saturated or unsaturated) or mixtures thereof and M⁺=monovalent cation. Examples include Sodium Cocomonoglyceride Sulfate (RCO=coco acyl, M⁺=Na⁺) and Ammonium Cocomonoglyceride Sulfate (RCO=coco acyl, M⁺=NH₄⁺);
Alkyl ether carboxylates

[chemical structure]

where R═C₈-C₂₄ alkyl (linear or branched, saturated or unsaturated) or mixtures thereof, n=1-20, and M⁺=monovalent cation. Examples include Sodium Laureth-13 Carboxylate (R═C₁₂ alkyl, M⁺=Na⁺, n=13), and Sodium Laureth-3 Carboxylate (R═C₁₂ alkyl, M⁺=Na⁺, n=3);
Alkyl ether sulfosuccinates

[chemical structure]

Where R═C₈-C₂₀ alkyl (linear or branched, saturated or unsaturated) or mixtures thereof, n=1-12, and M⁺=monovalent cation, such as Disodium Laureth Sulfosuccinate (R=lauryl, n=1-4, and M⁺=Na⁺);
Dialkyl sulfosuccinates

[chemical structure]

Where R═C₆-C₂₀ alkyl (linear or branched, saturated or unsaturated) or mixtures thereof and M⁺=monovalent cation, such as Diethylhexyl Sodium Sulfosuccinate (R=2-ethylhexyl, M⁺=Na⁺);
Alkylamidoalkyl sulfosuccinates

[chemical structure]

Where R═C₈-C₂₀ alkyl (linear or branched, saturated or unsaturated) or mixtures thereof, R′═C₂-C₄ alkyl (linear or branched), and M⁺=monovalent cation, such as Disodium Cocamido MIPA-Sulfosuccinate (RCO=coco acyl, R′=isopropyl, M⁺=Na⁺);
Alkyl sulfosuccinamates

[chemical structure]

Where R═C₈-C₂₀ alkyl (linear or branched, saturated or unsaturated) or mixtures thereof and M⁺=monovalent cation, such as Disodium Stearyl Sulfosuccinamate (R=stearyl, C₁₈H₃₇, M⁺=Na⁺);
Acyl glutamates

[chemical structure]

Where RCO═C₆-C₂₀ acyl (linear or branched, saturated or unsaturated) or mixtures thereof, R′═H or CH₃, M⁺=monovalent cation, such as Disodium Cocoyl Glutamate (RCO=coco acyl, R′═H, M⁺=Na⁺) and Disodium Lauroyl Glutamate (RCO=lauroyl, R′═H, M⁺=Na+);
Acyl aspartates

[chemical structure]

Where RCO═C₆-C₂₀ acyl (linear or branched, saturated or unsaturated) or mixtures thereof, R′═H or CH₃, M⁺=monovalent cation, such as Disodium N-Lauroyl Aspartate (RCO=lauroyl, R′═H, M⁺=Na⁺);
Acyl taurates

[chemical structure]

Where RCO═C₆-C₂₀ acyl (linear or branched, saturated or unsaturated) or mixtures thereof, R′═H or CH₃, M⁺=monovalent cation, such as Sodium Methyl Cocoyl Taurate (RCO=coco acyl, R′═CH₃, M⁺=Na⁺) and Sodium Cocoyl Taurate (RCO=lauroyl, R′═H, M⁺=Na⁺);
Acyl lactylates

[chemical structure]

Where RCO═C₈-C₂₀ acyl (linear or branched, saturated or unsaturated) or mixtures thereof, M⁺=monovalent cation, such as Sodium Lauroyl Lactylate (RCO=lauroyl, M⁺=Na⁺);
Acyl glycinates and acyl sarcosinates

[chemical structure]

Where RCO═C₈-C₂₀ acyl (linear or branched, saturated or unsaturated) or mixtures thereof, R′═H (glycinate) or CH₃ (sarcosinate), M⁺=monovalent cation, such as Sodium Cocoyl Glycinate (RCO=coco acyl, R′═H, M⁺=Na⁺), Ammonium Cocoyl Sarcosinate (RCO=coco acyl, R′═CH₃, M⁺=NH₄⁺) and Sodium Lauroyl Sarcosinate (RCO=lauroyl, R′═CH₃, M⁺=Na⁺);
Anionic derivatives of alkyl polyglucosides, including: Sodium Lauryl Glucoside Carboxylate, Disodium Coco-Glucoside Citrate, Sodium Coco-Glucoside Tartrate, Disodium Coco-Glucoside Sulfosuccinate; Sodium Cocoglucosides Hydroxypropylsulfonate, Sodium Decylglucosides Hydroxypropylsulfonate, Sodium Laurylglucosides Hydroxypropylsulfonate; Sodium Hydroxypropylsulfonate Cocoglucoside Crosspolymer, Sodium Hydroxypropylsulfonate Decylglucoside Crosspolymer, Sodium Hydroxypropylsulfonate Laurylglucoside Crosspolymer; Anionic polymeric APG derivatives, such as those described in O′Lenick, U.S. Pat. Nos. 7,507,399; 7,375,064; and 7,335,627); and combinations of two or more thereof, and the like.

Preferred non-soap anionic surfactants include: acyl isethionates, e.g. Sodium Cocoyl Isethionate; alkyl sulfosuccinates, e.g. Disodium Lauryl Sulfosuccinate; α-sulfo fatty acid esters, e.g. Sodium Methyl 2-Sulfolaurate; α-sulfo fatty acids, e.g. Disodium 2-Sulfolaurate; alkyl glyceryl ether sulfonates, e.g. Sodium Cocoglyceryl Ether Sulfonate; alkyl sulfates, e.g. Sodium Coco-Sulfate, and combinations of two or more thereof. Especially preferred are acyl isethionates. In certain preferred embodiments the acyl isethionate is Sodium Cocoyl Isethionate.

In certain preferred embodiments, the compositions of this invention comprise from greater than about 30 to less than about 70 weight percent of total non-soap anionic surfactants based on total weight of cleansing bar. In certain more preferred embodiments, the compositions comprise from about 35 to about 60 weight percent of total non-soap anionic surfactants, even more preferably from about 35 to about 55, and most preferably from about 40 to about 50 weight percent total non-soap anionic surfactants.

### Superhydrophilic Amphiphilic Copolymer

As used herein, the term “superhydrophilic amphiphilic copolymer,” (“SAC”) is defined as a copolymer that may be represented by the following general structure:

[chemical structure]

wherein an “SRU” is a superhydrophilic repeat unit as defined herein, an “ARU” is an amphiphilic repeat unit as defined herein, an “HRU” is a hydrophilic repeat unit as defined herein, wherein s≧2, a>0, h≧0, and the total number of repeat units, s+a+h is between 4 and about 1000. The term “between,” when used herein to specify a range such as “between 4 and about 1000,” is inclusive of the endpoints, e.g. “4” and “about 1000.” The total number of repeat units in the SAC is based on the weight-average molecular weight (Mw) of the SAC; thus the number of repeat units, as discussed herein are “weight average” as well. Further, all molecular weights described herein are in the units of Daltons (Da). As will be recognized by one of skill in the art, the pattern of repeat units (SRUs, ARUs, HRUs) incorporated in SACs of the present invention are generally random; however, they may also have alternating, statistical, or blocky incorporation patterns. In addition, SAC architectures may be linear, star-shaped, branched, hyperbranched, dendritic, or the like.

Those of skill in the art will recognize that total number of repeat units in a SAC (SRUs+ARUs+HRUs, i.e. s+a+h in the above formula) is synonymous with the term “degree of polymerization” (“DP”) of the SAC.

A “repeat unit” as defined herein and known the art is the smallest atom or group of atoms (with pendant atoms or groups, if any) comprising a part of the essential structure of a macromolecule, oligomer, block, or chain, the repetition of which constitutes a regular macromolecule, a regular oligomer molecule, a regular block, or a regular chain (definition from Glossary of Basic Terms in Polymer Science, A. D. Jenkins et al. Pure Appl. Chem. 1996 68, 2287-2311.)

As will be recognized by those of skill in the art in light of the description herein and knowledge of the art, the backbone of a polymer derived from ethylenically-unsaturated monomers comprises repeat units including one or two, or in the case of alternating polymers four, carbon atoms that were unsaturated in the monomers prior to polymerization, and any pendant groups of such carbons. For example, polymerization of an ethylenically-unsaturated monomer of the formula: (A)(Y)C═C(B)(Z) will generally result in a polymer comprising repeat units of the formula:

[chemical structure]

comprising the two previously unsaturated carbons of the monomer and their pendant groups (examples of which are described herein below, for example in the descriptions of SRUs, ARUs, and HRUs). However, if the pendant groups of the two carbons are the same such that, for example in the formula above, A-C—Y and B—C—Z are the same moiety, then each of such one carbon units and its pendant groups (A-C—Y or B—C—Z, being the same) are considered to be the repeat unit comprising only one previously unsaturated carbon from the monomer (e.g. the repeat unit of a homopolyer derived from ethylene, H₂C═CH₂ is [—[CH₂]—] not [—[CH₂CH₂]—]. With regard only to alternating copolymers, which as known in the art are defined as those polymers in which the repeat units derived from the two comonomers alternate consistently throughout the polymer (as opposed to the random polymerization of co-monomers to form a polymer in which repeat units derived from the two monomers are randomly linked throughout the polymer or the block copolymerization of comonomers to form non-alternating blocks of repeat units derived from the two monomers), the repeat unit is defined as the unit derived from one of each of the co-monomers comprising four carbons that were previously ethylenically-unstaurated in the two comonomers prior to polymerization. That is, maleic anhydride and vinyl methyl ether are used in the art to form an alternating copolymer, poly(maleic anhydride-alt-vinyl methyl ether) having repeat units of the structure:

[chemical structure]

For saccharide-based polymers whose backbone is formed by linking sugar rings, the repeat unit generally comprises the sugar ring and pendant groups (as shown herein below, for example in the descriptions of SRUs, ARUs, and HRUs). Examples of such repeat units also include sugar ring repeat units with pendant sugar rings, for example, Glactomannans are polysaccharides comprised of a mannose (monosaccharide-based) backbone. Pending from some but not all of the mannose groups in the backbone (and arranged in either a random or block fashion) are pendant galactose groups. As will be readily understood by one skilled in the art, this structure is best described as having, two repeat units, mannose and mannose-galactose.

[chemical structure]

For alternating saccharide-based polymers, then the repeat unit is the two sugar rings derived from the alternating sugar-based monomers and their pendant groups. For example, Hyaluronan is an alternating saccharide copolymer derived from two saccharides, D-glucuronic acid and D-N-acetylglucosamine that alternate to give a disaccharide repeat units.

[chemical structure]

A “hydrophobic moiety” is hereby defined as a nonpolar moiety that contains at least one of the following: (a) a carbon-carbon chain of at least four carbons in which none of the four carbons is a carbonyl carbon or has a hydrophilic moiety bonded directly to it; (b) two or more alkyl siloxy groups (—[Si(R)₂—O]—); and/or (c) two or more oxypropylene groups in sequence. A hydrophobic moiety may be, or include, linear, cyclic, aromatic, saturated or unsaturated groups. In certain preferred embodiments, hydrophobic moieties comprise a carbon chain of at least six or more carbons, more preferably seven or more carbons in which none of the carbons in such chain have a hydrophilic moiety bonded directly thereto. Certain other preferred hydrophobic moieties include moieties comprising a carbon chain of about eight or more carbon atoms, more preferably about 10 or more carbon atoms in which none of the carbons in such chain have a hydrophilic moiety bonded directly thereto. Examples of hydrophobic functional moieties may include esters, ketones, amides, carbonates, urethanes, carbamates, or xanthate functionalities, and the like, having incorporated therein or attached thereto a carbon chain of at least four carbons in which none of the four carbons has a hydrophilic moiety bonded directly to it. Other examples of hydrophobic moieties include groups such as poly(oxypropylene), poly(oxybutylene), poly(dimethylsiloxane), fluorinated hydrocarbon groups containing a carbon chain of at least four carbons in which none of the four carbons has a hydrophilic moiety bonded directly to it, and the like.

As used herein, the term “hydrophilic moiety,” is any anionic, cationic, zwitterionic, or nonionic group that is polar. Nonlimiting examples include anionics such as sulfate, sulfonate, carboxylic acid/carboxylate, phosphate, phosphonates, and the like; cationics such as: amino, ammonium, including mono-, di-, and trialkylammonium species, pyridinium, imidazolinium, amidinium, poly(ethyleneiminium), and the like; zwitterionics such as ammonioalkylsulfonate, ammonioalkylcarboxylate, amphoacetate, and the like; and nonionics such as hydroxyl, sulfonyl, ethyleneoxy, amido, ureido, amine oxide, and the like.

As used herein, the term “superhydrophilic repeat unit,” (“SRU”) is defined as a repeat unit that comprises two or more hydrophilic moieties and no hydrophobic moieties. For example, SRUs may be derived from ethylenically-unsaturated monomers having two or more hydrophilic moieties and no hydrophobic moieties, including repeat units of the general formulae:

[chemical structure]

wherein A, B, Y, and Z collectively include at least two hydrophilic moieties and no hydrophobic moieties; or

[chemical structure]

wherein W and X collectively include at least two hydrophilic moieties. Illustrative examples of such SRUs include, but are not limited to, those derived from superhydrophilic monomers described herein and the like, such as:

[chemical structure]

which is derived from glyceryl methacrylate; or others such as

[chemical structure]

which is derived from 4-Hydroxybutyl itaconate; and the like.

Other examples of SRUs include saccharide-based repeat units including repeat units derived from fructose, glucose, galactose, mannose, glucosamine, mannuronic acid, guluronic acid, and the like, such as:

[chemical structure]

wherein A, B, U, V, W, X, Y, and Z collectively include at least two hydrophilic moieties and no hydrophobic moieties, one example of which includes

[chemical structure]

which is a α(1→4)-D-glucose SRU; or

[chemical structure]

wherein A, B, U, V, and W collectively include at least two hydrophilic moieties and no hydrophobic moieties, one example of which includes

[chemical structure]

a β(2→1)-D-fructose SRU; and the like. As will be recognized by those of skill in the art, monosaccharide repeat units may be linked in various fashions, that is, through various carbons on the sugar ring e.g. (1→4), (1→6), (2→1), etc. Any of such linkages, or combinations thereof, may be suitable for use herein in monosaccharide SRUs, ARUs, or HRUs.

Other examples of SRUs include repeat units derived from amino acids, including, for example, repeat units of the formula:

[chemical structure]

wherein R includes a hydrophilic repeat unit, examples of which include an aspartic acid SRU, and the like.

[chemical structure]

As used herein, the term “amphiphilic repeat unit,” (“ARU”) is defined as a repeat unit that comprises at least one hydrophilic moiety and at least one hydrophobic moiety. For example, ARUs may be derived from ethylenically-unsaturated monomers having at least one hydrophilic moiety and at least one hydrophobic moiety, including repeat units of the general formulae

[chemical structure]

wherein A, B, Y, and Z collectively include at one hydrophilic moiety and at least one hydrophobic moiety; or

[chemical structure]

wherein W and X collectively include at one hydrophilic moiety and at least one hydrophobic moiety; examples of which include

[chemical structure]

sodium 2-acrylamidododecylsulfonate amphiphilic repeat unit (ARU), and the like. Other examples of ARUs include saccharide-based repeat units including repeat units derived from including repeat units derived from fructose, glucose, galactose, mannose, glucosamine, mannuronic acid, guluronic acid, and the like, such as:

[chemical structure]

wherein A, B, U, V, W, X, Y, and Z collectively include at least one hydrophilic moiety and at least one hydrophobic moiety, or

[chemical structure]

wherein A, B, U, V, and W collectively include at least one hydrophilic moiety and at least one hydrophobic moiety, examples of which include

[chemical structure]

1,2-epoxydodecane modified a (1→4)-D-glucose ARU, and the like. Other examples of ARUs include repeat units derived from amino acids, including, for example, repeat units of the formula:

[chemical structure]

wherein R includes a hydrophobic group, examples of which include

[chemical structure]

a phenylalanine ARU; and the like.

As will be readily understood by those of skill in the art, the term “hydrophilic repeat unit,” (“HRU”) is defined as a repeat unit that comprises one and only one hydrophilic moiety and no hydrophobic moieties. For example, HRUs may be derived from ethylenically-unsaturated monomers having one and only one hydrophilic moiety and no hydrophobic moieties, including repeat units of the general formulae

[chemical structure]

wherein A, B, Y, and Z collectively include one and only one hydrophilic moiety and no hydrophobic moieties; or

[chemical structure]

wherein W and X collectively include one and only one hydrophilic moiety and no hydrophobic moieties, examples of which include

[chemical structure]

methacrylic acid hydrophilic repeat unit (HRU); and the like. Other examples of HRUs include saccharide-based repeat units including repeat units derived from fructose, glucose, galactose, mannose, glucosamine, mannuronic acid, guluronic acid, and the like, such as:

[chemical structure]

wherein A, B, U, V, W, X, Y, and Z collectively include one and only one hydrophilic moiety and no hydrophobic moieties, or

[chemical structure]

wherein A, B, U, V, and W collectively include one and only one hydrophilic moiety and no hydrophobic moieties. One example of saccharide-based hydrophilic repeat unit includes methylcellulose HRU, (methyl-substituted poly[β(1→4)-D-glucose], DS=2.0)

[chemical structure]

Other examples of HRUs include repeat units derived from amino acids, including, for example, repeat units of the formula:

[chemical structure]

wherein R is neither a hydrophilic nor hydrophobic moiety, one example of which includes

[chemical structure]

alanine HRU; and the like. As will be recognized by one of skill in the art, in any of the formulae herein, examples of moieties that are neither hydrophilic nor hydrophobic include hydrogen, C₁-C₃ alkyl, C₁-C₃ alkoxy, C₁-C₃ acetoxy, and the like.

As noted above, applicants have discovered unexpectedly that certain SACs are suitable for use in cleansing bars having good processability as well as relatively low irritation and relatively high amounts of foam associated therewith. According to certain preferred embodiments, applicants have discovered that SACs having a DP between 4 and about 1000 repeat units, exhibit such significant and unexpected combination of low-irritation and high foaming properties. Examples of preferred SACs suitable for use in accord with such embodiments, include those having a DP of between 4 and about 500, more preferably 4 and about 200, more preferably 4 and about 100, more preferably 4 and about 50 repeat units. Other examples include those having a DP of between 5 and about 500, more preferably 5 and about 200, more preferably 5 and about 100, more preferably 5 and about 50 repeat units. Other examples include those having a DP of between 6 and about 200, more preferably 6 and about 100, more preferably 6 and about 50 repeat units. Other examples include those having a DP of between 7 and about 100, more preferably 7 and about 50 repeat units.

According to certain embodiments, applicants have further discovered that certain preferred SACs are capable of forming compositions having relatively low “Dynamic Surface Tension Reduction Time” (that is, the time required to reduce surface tension of pure water from 72 mN/m to 55 mN/m, “t_{γ=55}”, associated with a particular composition, which value is measured conventionally via the Drop Shape Analysis Test (“DSA Test”) described in further detail below) and are preferred for use in compositions having significant and unexpected combinations of low-irritation and high foaming properties, as compared to comparable compositions. According to certain preferred embodiments, the SACs of the present invention have a t_{γ=55} of about 120 seconds (s) or less. In certain more preferred embodiments, the SACs of the present invention have a t_{γ=55} of about 75 seconds or less, more preferably about 50 or less, more preferably about 45 or less.

Drop Shape Analysis (DSA, also known as Pendant Drop Method or PDM) is a well-known method for measuring the static interfacial or surface tension as a function of time. The surface tension measured by DSA is determined by fitting the shape of the hanging drop (captured in a video image) to the Young-Laplace equation, which relates inter-facial tension to drop shape. The Laplace equation is the mechanical equilibrium condition for two homogeneous fluids separated by an interface (Handbook of Applied Surface and Colloid Chemistry, Vol. 2; Holmberg, K., Ed.; John Wiley & Sons: Chicester, U.K., 2002, pp 222-223). It relates the pressure difference across a curved interface to the surface tension and the curvature of the interface: Solutions for the determination of surface tension may be prepared as follows: a polymer sample (1150 mg active solids) is diluted in Millipore-Q deionized water (200 mL) in an acid-washed glass flask with glass stopper. This stock solution is mixed by manually shaking for five minutes and allowed to stand overnight. A dilution (¼) of the stock solution is prepared by further diluting the stock solution with Millipore-Q water in acid-washed glassware—this is the sample is used for DSA analysis. The samples are analyzed using a DSA 100 instrument (Krüss GmbH, Hamburg, Germany) operating at 25.0° C. The drop is monitored over 120 seconds and images are captured approximately every 0.16 seconds for the first 10 seconds, every 0.5 seconds for the next 50 seconds, and every second for the last 60 seconds. All of the captured images are analyzed to determine the surface tension at each time frame. Surface tension values are calculated using the Drop Shape Analysis (DSA) for Windows™ package (Krüss GmbH, Hamburg, Germany). Dynamic reduction of surface tension is reported as the time in seconds required to reduce the surface tension of the test solution to 55 mN/m, t_{γ=55}. The reported values of t_{γ=55} are the average of three individual measurement runs.

According to certain preferred embodiments, SACs suitable for use in the present invention exhibit a mole percent (mol %) of amphiphilic repeat units (amphiphilic mol %=(a/s+a+h)) of less than 10% such as those having a mol % of ARUs of from about 5 to about 10 mol %.

The SACs useful in the present invention may be of any suitable molecular weight (provided the required DP is met). In certain preferred embodiments, the SAC has a weight average molecular weight from about 1000 grams/mol to about 200,000 grams/mol. In a preferred embodiment, the SAC has a weight average molecular weight of from about 1000 to about 100,000, more preferably from about 1,000 to about 75,000, more preferably from about 1,000 to about 50,000, more preferably from about 1,000 to about 25,000, and more preferably from about 1,000 to about 10,000, and more preferably from about 3,000 to about 10,000. Furthermore, according to certain preferred embodiments, SACs useful in the present invention are provided in readily water-soluble, free flowing, solid forms, such as powders.

SACs suitable for use in the present invention include polymers of various chemical classifications and obtained via a variety of synthetic routes. Examples include polymers having a backbone that substantially comprises a plurality of carbon-carbon bonds, preferably essentially consists or consists only of carbon-carbon bonds and polymers having a backbone comprising a plurality of carbon-heteroatom bonds (as will be recognized by those of skill in the art, the backbone refers generally to the portion of repeat units in a polymer that is covalently bonded to adjacent repeat units (vs. “pendant groups”).

Examples of synthetic routes for obtaining SACs of the present invention include copolymerization of (i) one or more ethylenically unsaturated amphiphilic comonomers with (ii) one or more ethylenically unsaturated superhydrophilic comonomers, and optionally, (iii) one or more ethylenically unsaturated hydrophilic comonomers. Nonlimiting examples of ethylenically unsaturated amphiphilic comonomers include those having the following structure:

[chemical structure]

where R₁═R₂═H, R₃═H or CH₃, and R₄ comprises Amphiphilic (Amphil) group, or
where R₁═R₂═H, R₃ comprises a hydrophilic group (Hphil), and R₄ comprises hydrophobic group (Hphob), or
where R₁, R₃ are independently H or CH₃, R₂ comprises Hphil, and R₄ comprises Hphob group, or
where R₁, R₄ are independently H or CH₃, R₃ comprises Hphil, and R₄ comprises Hphob group, or
where R₂, R₃ are independently H or CH₃, R₁ comprises Hphil, and R₄ comprises Hphob group

### Anionic:

ω-alkeneoates: e.g. sodium 11-undecenoate

[chemical structure]

where R₁=any linear or branched carbon chain containing more than 5 carbon atoms and M=H⁺, NH₄⁺, or any Group IA alkali metal cation.
(Meth)acrylamidoalkylcarboxylates and (meth)acryloyloxyalkylcarboxylates: e.g. sodium 11-acrylamidoundecanoate, sodium 11-methacryloyloxyundecanoate

[chemical structure]

where R₂═H or CH₃, X═O or NH, R₃=any linear or branched carbon chain containing more than 5 carbon atoms and M=H⁺, NH₄⁺, or any Group IA alkali metal cation.
(Meth)acrylamidoalkylsulfonic acids: e.g. 2-acrylamidododecylsulfonic acid

[chemical structure]

where R₄═H or CH₃, X═O or NH, R₅=any linear or branched carbon chain containing more than 5 carbon atoms and M=H⁺, NH₄⁺, or any Group IA alkali metal cation.
Allylalkylsulfosuccinates: e.g. sodium allyldodecylsulfosuccinate (TREM LF-40, Cognis)

[chemical structure]

where R₆=any linear or branched carbon chain containing more than 5 carbon atoms and M=H⁺, NH₄⁺, or any Group IA alkali metal cation.

### Cationic:

Quaternized aminoalkyl(meth)acrylamides and aminoalkyl(meth)acrylates: e.g. (3-methacrylamidopropyl)dodecyldimethylammonium chloride, (2-methacryloyloxyethyl)dodecyl dimethylammonium chloride

[chemical structure]

where R₇═H or CH₃, X═O or NH, R₈=any linear or branched carbon chain containing 5 or less carbon atoms, R₉═H, CH₃, CH₂CH₃ or CH₂CH₂OH, R₁₀=any linear or branched carbon chain containing more than 5 carbon atoms and Z=any Group VII-A halide anion, OR where R₇═H or CH₃, X═O or NH, R₈=any linear or branched carbon chain containing more than 5 carbon atoms, R₉, R₁₀ are independently H, CH₃, CH₂CH₃ or CH₂CH₂OH, and Z=any Group VII-A halide anion
Quaternized vinylpyridines: e.g. (4-vinyl)dodecylpyridinium bromide

[chemical structure]

where R₁₁=any linear or branched carbon chain containing more than 5 carbon atoms and Z=any Group VII-A halide anion.
Alkyldiallylmethylammonium halides: e.g. diallyldodecylmethylammonium chloride

[chemical structure]

where R₁₂═H, CH₃ or R₁₃, R₁₃=any linear or branched carbon chain containing more than 5 carbon atoms and Z=any Group VII-A halide anion.

### Zwitterionic:

Ammonioalkanecarboxylates: e.g. 2-[(11-(N-methylacrylamidyOundecyl)dimethylammonio]acetate

[chemical structure]

where R₁₄═H or CH₃, X═O or N, R₁₅═H, CH₃, CH₂CH₃ or CH₂CH₂OH, R₁₆=any linear or branched carbon chain more than 5 carbon atoms, R₁₇=any linear or branched carbon chain containing 5 or less carbon atoms, and R₁₈═H, CH₃, or nothing.
Ammonioalkanesulfonates: e.g. 3-[(11-methacryloyloxyundecyl)dimethylammonio]propanesulfonate

[chemical structure]

where R₁₉═H or CH₃, X═O or N, R₂₀═H, CH₃, CH₂CH₃ or CH₂CH₂OH, R₂₁=any linear or branched carbon chain more than 5 carbon atoms, R₂₂=any linear or branched carbon chain containing 5 or less carbon atoms, and R₂₃═H, CH₃, or nothing.

### Nonionic:

ω-methoxypoly(ethyleneoxy)alkyl-(meth)acrylates: e.g. co-methoxypoly(ethyleneoxy)undecyl-methacrylate

[chemical structure]

where R₂₄═H or CH₃, X═O, R₂₅=any linear or branched carbon chain more than 5 carbon atoms, n is an integer from about 4 to about 800, and R₂₆=any linear or branched carbon chain containing 5 or less carbon atoms
ω-alkoxypoly(ethyleneoxy)-α-(meth)acrylates and ω-alkoxypoly(ethyleneoxy)-α-itaconates: e.g. steareth-20 methacrylate, ceteth-20 itaconate

[chemical structure]

where R₂₇═H, CH₃, or CH₂COOH, X═O, R₂₈=any linear or branched carbon chain more than 5 carbon atoms, and n is an integer from about 4 to about 800

### Nonlimiting Examples of Ethylenically Unsaturated Superhydrophilic Comonomers Include the Following, and the Like:

### Nonionic:

glyceryl(meth)acrylate
sucrose mono(meth)acrylate, glucose mono(meth)acrylatetris(hydroxymethyl)acrylamidomethane, 1-(2-(3-(allyloxy)-2-hydroxypropylamino)ethyl)imidazolidin-2-one (Sipomer® WAM from Rhodia)

### Anionic:

itaconic acid, hydrophilic derivatives thereof, and alkali metal salts thereof
crotonic acid, hydrophilic derivatives thereof, and alkali metal salts thereof
maleic acid, hydrophilic derivatives thereof, and alkali metal salts thereof

### Cationic:

2-(meth)acryoyloxy-N-(2-hydroxyethyl)-N,N-dimethylethylammonium chloride, 3-(meth)acrylamido-N-(2-hydroxyethyl)-N,N-dimethylpropylammonium chloride, 3-(meth)acrylamido-N,N-bis(2-hydroxyethyl)-N-methylpropylamonium chloride, N-(2-(bis(2-hydroxyethyl)amino)ethyl)(meth)acrylate, N-(3-(bis(2-hydroxyethyl)amino)propyl)(meth)acrylamide, N-(2-((meth)acryloyloxy)ethyl)-N,N,N′,N′,N′-pentamethylethane-1,2-diammonium dichloride

### Zwitterionic:

3-[(3-(meth)acrylamidopropyl)dimethylammonio]propanesulfonate, 3-(3-(meth)acrylamidopropyldimethylammonio)propionate, 3-(3-(meth)acrylamidopropyldimethylammonio)acetate, 2-(meth)acryloyloxyethylphosphorylcholine, and the like

### Nonlimiting Examples of Optional Ethylenically Unsaturated Hydrophilic Comonomers Include the Following, and the Like:

### Nonionic:

e.g. acrylamide, N,N-dimethylacrylamide, N-vinylformamide,hydroxyethyl(meth)acrylate, (meth)acrylamidoethylethyleneurea, methoxypoly(ethyleneoxy)-(meth)acrylate, and the like

### Anionic:

acrylic acid, β-carboxyethyl acrylate, 2-acrylamido-2-methylpropanesulfonic acid, 3-acrylamido-3-methylbutanoic acid, sodium allylhydroxypropylsulfonate

### Cationic:

N,N-dimethylaminoethyl methacrylate, N,N-dimethylpropyl(meth)acrylamide, (3-(meth)acrylamidopropyl)trimethylammonium chloride, diallyldimethylammoniumchloride

### By Way of Non-Limiting Example, SACs Made Via Copolymerization of Ethylenically-Unsaturated Monomers Include:

[chemical structure]

poly[tris(hydroxymethyl)acrylamidomethane-co-sodium 2-acrylamidododecylsulfonate]

[chemical structure]

poly[glyceryl methacrylate-co-(2-methacryloyloxyethyl)dodecyldimethylammonium chloride]; and the like.

Additional synthetic routes for achieving the SACs of the present invention include via post-polymerization modification of precursor polymers comprising SRUs to render some repeat units amphiphilic. Nonlimiting examples include the reaction of superhydrophilic polymers comprised of repeat units comprising multiple hydroxyl functionalities, for example, starch, hydroxyethylcellulose, dextran, inulin, pullulan, poly(glyceryl methacrylate), poly[tris(hydroxymethyl)acrylamidomethane)], or poly(sucrose methacrylate), with reagents that will result in amphiphilic repeat units.

### Examples of Suitable Reaction Schemes Include:

i) Esterification with alkenyl succinic anhydrides
ii) Etherification with 1,2-epoxyalkanes
iii) Etherification of with 3-chloro-2-hydroxypropylalkyldimethylammonium chlorides
iv) Esterification with monoalkyl phosphate esters

According to certain preferred embodiments, the SAC for use in the present invention is a polymer having multiple hydroxyl functionalities that is then post-polymerization modified to convert some of the repeat units to ARUs. In one particularly preferred embodiment, the polymer, e.g., a starch such as a starch dextrin polymer, that is esterified with an alkenyl succinic anhydride to convert some of the superhydrophilic anhyroglucose units to ARUs. The structure of one such suitable resulting SAC may be the C-6 sodium dextrin alkenylsuccinate, represented below:

[chemical structure]

For example, the SAC may be a sodium dextrin dodecenylsuccinate, if R═C₁₂H₂₃. As will be recognized by one of skill in the art, such alkenyl succinate esters of polysaccharides may be synthesized as described, for example, in U.S. Pat. No. 2,661,349, incorporated herein by reference. Depending on the nature of the reaction conditions, molecular architecture, type of sugar repeat units, branch points and molecular weight, the modification of the sugar repeat units (AGU) may also occur at the C-2, C-3 or C-4 positions in addition to the C-6 position shown above.

The SACs derived from the reaction of the starting polysaccharide with the hydrophobic reagent comprises a polysaccharide bound with the hydrophobic reagent. In certain preferred embodiments, the SAC is a starch based polysaccharide modified with one or more hydrophobic reagents. Examples of suitable starches include those derived from such plants as corn, wheat, rice, tapioca, potato, sago, and the like. Such starches can be of a native variety or those developed by plant breeding or by gene manipulation.

In an embodiment of the invention, the starches include either the waxy versions of such starches (containing less than 5% amylose), high amylose starches (containing more than 40% amylose), those with a modified chainlength (such as those disclosed in U.S. Pat. No. 5,9545,883, which is incorporated by reference in its entirety herein), and/or combinations thereof. In certain preferred embodiments, the starting starch is potato starch or tapioca starch. In certain other preferred embodiments, the starting starch is a waxy potato starch or waxy tapioca starch.

In certain embodiments, the starch-based polysaccharide is modified by dissolving such low molecular weight starch or “dextrin” in water and reacting such starch with a hydrophobic reagent. The starch is desirably processed to lower its molecular weight by techniques known in the art, e.g., action of acid and heat, enzymatic, or thermal processing. The low molecular weight starch is dissolved in water, with optional heating, to form an aqueous solution and the pH of the aqueous solution is adjusted to about 2.0 by addition of an acid, such as a mineral acid (e.g. hydrochloric acid), to the solution. To minimize the removal of water at the end of the reaction, it is preferred that the starch solution be prepared at the highest solids possible. In an exemplary embodiment, a suitable working range for aqueous solids of the low molecular weight starch is from about 10% to about 80% starch based on the total weight of the solution. Preferably, the percent solids of the low molecular weight starch is from about 25% to about 75% based on total weight of solution. In another embodiment, the percent solids of the low molecular weight starch may be from about 35% to about 70% by weight of the total solution.

The viscosity of an aqueous solution of the SAC is desirably low to minimize the detrimental effect of a high solids level of surfactant with pumping or flow of the solution. For this reason, in an embodiment of the invention, the Brookfield viscosity measured at room temperature (about 23° C.) at 200 rpm using spindle #3 for the SACs of this invention may be less than about 1000 cps at 10% aqueous solids based on the total weight of the solution. In another embodiment, the Brookfield viscosity measured at room temperature (about 23° C.) at 200 rpm using spindle #3 of the 10% aqueous solution may be less than about 25 cps. In yet another embodiment, the Brookfield viscosity measured at room temperature (about 23° C.) at 200 rpm using spindle #3 of a 10% aqueous solution will be less than about 10 cps. In a further step, the conversion of some of the superhydrophilic anhydroglucose units to ARUs is performed by reacting one or more hydrophobic reagents (e.g., alkenyl succinic anhydride) with the starch in the aqueous solution at a pH of about 8.5 at about 40° C. for about 21 hours to form an aqueous solution of SAC. Additional process steps such as cooling the aqueous solution of SAC to about 23° C. and neutralizing the solution to a pH of about 7.0 may then be performed. In an embodiment of the invention, the pH is adjusted by using a mineral acid, such as hydrochloric acid.

In certain preferred embodiments, the starch-based polysaccharide is modified with alkenyl succinic anhydride. In certain preferred embodiments, the alkenyl succinic anhydrides is dodeceneylsuccinic anhydride (DDSA). Exemplary treatment levels of the DDSA, on the dry basis of low molecular weight ranges from about 3 to about 25%. In another embodiment, the treatment level may be from about 5 to about 15% DDSA based on the dry weight of low molecular weight starting starch.

In an embodiment of the invention, the SACs derived from the reaction of the starting polysaccharide and DDSA, the bound DDSA on the starch-based polysaccharide may be from about 3 about 15% based on the weight of dry starch. In another embodiment, the bound DDSA will be between 5 and 12% based on the dry weight of starch.

In an embodiment of the invention, the solution containing the low molecular weight polysaccharide may be then contacted with the DDSA using sufficient agitation to keep the DDSA uniformly dispersed throughout the solution. The reaction may then be run at temperatures between 25° C. and 60° C. while the pH of the reaction is kept from about 7.0 and about 9.0 by the slow and controlled addition of a suitable base. Some examples of such suitable base materials include, but not limited to, sodium hydroxide, potassium hydroxide, sodium, carbonate, potassium carbonate and calcium oxide (lime) and the like.

In an exemplary embodiment of the invention, the hydrophobic reagent is a highly branched version of DDSA containing a 12 carbon side chain made from tetramerization of propene. It has been found that when the tetrapropene is then reacted with maleic anhydride in an ene-type reaction, it forms highly branched tetrapropenyl succinic anhydride (TPSA). Because this material is a slightly viscose oil and has acceptable water solubility (e.g., at about 2-5% in water at 23° C.), this reagent is capable of reacting favorably with the low molecular weight polysaccharide. In an embodiment of this invention, therefore, the hydrophobic reagent used to modify the low molecular weight starch may be TPSA.

In certain other embodiments, the starch-based polysaccharide is modified with a long chain quaternary compound having at least one chain containing 3 or more carbon atoms. In another embodiment the long chain quaternary compound has at least one chain containing 6 or more and more preferably 12 or more carbon atoms, such as 3-chloro-2-hydroxpropyl-dimethyldodecylammonium chloride (sold commercially as QUAB(r) 342) or the epoxide form of such compound, 2,3epoxypropyldimethyldodecylammonium chloride.

In still another embodiment of the invention, the one or more hydrophobic reagents may be a combination of reagents, such as, for example, a succinic anhydride and a long chain quaternary ammonium compound. A dialkylanhydride, such as stearyl anhydride, may also be suitable in the present invention.

In a further embodiment, the hydrophobic reagent has a molecular weight greater than about 220. Preferably, the hydrophobic reagent has a molecular weight greater than about 250. In a further embodiment, the hydrophobic reagent has a molecular weight less than about 200,000.

In certain preferred embodiments, the modified starch-based polysaccharide has a weight average molecular weight of below 200,000. In certain preferred embodiments, the modified starch-based polysaccharide has a weight average molecular weight of from about 1,000 to 25,000 or 1,500 to 15,000 and more preferably about 3,000 to about 10,000.

In addition to starch-based polysaccharides, other polysaccharides are suitable for use in the present invention. Such polysaccharides may be derived from plant sources and those based on sugar-type repeat units. Some non-limiting examples of these polysaccharides are guar, xanthan, pectin, carrageenan, locust bean gum, and cellulose, including physical and chemically modified derivatives of the above. In embodiments of the invention, physical, chemical and enzymatic degradation of these materials may be necessary to reduce the molecular weight to the desired range to provide the viscosity for the desired application. Chemical modification can also be performed to provide additional functional properties (e.g., cationic, anionic or non-ionic) such as treatment with propylene oxide (PO), ethylene oxide (EO), alkyl chlorides (alkylation) and esterification such as 3-chloro-2-hydroxypropyl-trimethylammonium chloride, sodium tripolyphosphate, chloroacetic acid, epichlorohydrin, phosphorous oxychloride and the like.

Another non-limiting example of a SAC derived from post-polymerization modification of a polysaccharide includes:

[chemical structure]

Dextran (poly[α(1→6)-D-glucose]) modified with 3-chloro-2-hydroxypropyllauryldimethylammonium chloride; and the like.

Other synthetic routes may include polymerization of amino acids and/or postpolymerization modification of polyaminoacids to achieve a SAC of the present invention, as well as, post-polymerization modification of hydrophilic polymers or amphiphilic polymers to achieve SACs of the present invention, and the like.

According to certain embodiments, the SAC is used in a concentration from greater than about 0.1% to about 25% by weight of active SAC in the composition. Preferably, the SAC is in a concentration from about 0.5 to about 10%, more preferably from about 1 to about 7.5%, even more preferably from about 2 to about 6% of active SAC in the composition.

To obtain good processability and usage properties, the composition is stabilized with a hydrophobic binder that functions as a binder and as a plasticizer to facilitate better extrusion and stamping of the bar. As used herein “hydrophobic binder” refers to a compound that includes a hydrophobic moiety, is generally insoluble in water. The hydrophobic binder is preferably solid at room temperature but either melts or becomes malleable and flowable at elevated temperatures (≧30° C.). The hydrophobic binder may also have additional functions, such as an in-use as an emollient to the skin being cleansed.

Examples of classes of suitable hydrophobic binders include fatty acids, fatty alcohols, esters of alcohols with fatty acids, polyol esters, waxes, mixed glycerides, triglycerides, hydrogenated tri glycerides, hydrogenated metathesis products of unsaturated triglycerides, and combinations thereof.

Suitable fatty acids and fatty alcohols include those having from about 8 to about 24 carbon atoms, such as those having at least 16 carbon atoms, for example stearic acid and steryl alcohol. Suitable esters of alcohols with fatty acids include those having at least about 16 carbon atoms, for example synthetic beeswax. Suitable polyol esters include glyceryl esters such as Glyceryl Stearate or Glyceryl Distearate; sorbitan esters, such as Sorbitan Sesqustearate or Sorbitan Tristearate, and methyl glucoside esters, such as Methyl Glucose Dioleate or Methyl Glucose Distearate.

As used herein “wax” refers to hydrophobic compounds having a melting point that is above 30° C. The wax may be, hydrocarbon; animal, vegetable, mineral or synthetic. According to certain embodiments the wax includes or is selected from straight or branched chain alkanes or alkenes, ketones, diketones, primary or secondary alcohols, aldehydes, sterol esters, terpenes, and esters, such as those having a carbon chain length ranging from C₁₂-C₃₈. According to certain preferred embodiments the wax includes esters of alcohol (glycerol or other than glycerol) and long chain fatty acids. Suitable naturally occurring waxes include Beeswax, Lanolin Wax, Copernicia Cerifera (Carnauba) Wax, and Simmondsia Chinensis (Jojoba) Seed Wax. Suitable petroleum derived waxes include Paraffin, Microcrystalline Wax, and Petrolatum. Suitable mixed glycerides include those having an average carbon chain length at least about 12, for example, Cocoglycerides, Olive Glycerides, Palm Glycerides, and Palm Kemal Glycerides. Suitable triglycerides, include Butyrospermum Parkii (Shea) Butter, Theobroma Cacao (Cocoa) Seed Butter, Simmondsia Chinensis (Jojoba) Seed Oil, and Cocos Nucifera (Coconut) Oil. Suitable hydrogenated triglycerides, include Hydrogenated C12-18 Triglycerides, Hydrogenated Castor Oil, and Hydrogenated Jojoba Oil. Suitable Hydrogenated metathesis products of unsaturated triglycerides, include

### Hydrogenated Soy Polyglycerides.

Any suitable total amount of hydrophobic binder may be used in cleansing bars of the present invention. In certain embodiments, the total concentration of hydrophobic binder is from 5 percent to about 50 percent. In certain preferred embodiments, the total concentration of hydrophobic binder is from 10 percent to about 50 percent, preferably from about 15 percent to about 50 percent, more preferably from 20 percent to about 50 percent, and even more preferably 20 percent to about 40 percent.

According to certain preferred embodiments, the hydrophobic binder includes a C₈-C₂₄ fatty acid of the formula R—COOH, where R═C₇-C₂₃ alkyl, linear or branched, saturated or unsaturated fatty acid. According to certain particularly preferred embodiments the fatty acid includes or consists of a majority of stearic acid, palmitic acid, blends of C₁₆-C₁₈ linear saturated fatty acids, coconut fatty acids, or combinations thereof.

As used herein “water soluble bar hardener” refers to a water-soluble material that tends to provide increased hardness to the cleansing bar. Examples of classes of suitable water-soluble bar hardeners include inorganic metal cation salts of organic or inorganic acids. Examples of inorganic metal cation salts of organic acids include, for example, (sodium) salts isethionic acid, lactic acid, and citric acid. Examples of inorganic metal cation salts of inorganic acids include, for example, simple sodium salts, such as sodium chloride and sodium sulfate. According to certain preferred embodiments, the water soluble bar hardener is selected from sodium chloride and sodium isethionate.

Any suitable total amount of water soluble bar hardener may be used in cleansing bars of the present invention. In certain embodiments, the total concentration of water soluble bar hardener is from 0.25 percent to about 10 percent. In certain preferred embodiments, the total concentration of water soluble bar hardener is from 0.5 percent to about 5 percent, preferably from about 0.5 percent to about 3 percent.

Cleansing bars of the present invention may further include a zwitterionic surfactant. As used herein, “zwitterionic surfactant” refers to as used herein refers to an amphiphilic molecule comprising a hydrophobic group and one or more hydrophilic groups comprising two moieties of opposite formal charges or capable of bearing opposite formal charges as a function of acid-base properties and solution pH. Any suitable zwitteronic surfactant may be used in the present invention.

Examples of suitable zwitteronic surfactants include:
Alkyl betaines of the formula:

[chemical structure]

where R═C₆-C₂₄ alkyl (saturated or unsaturated) or mixtures thereof. Examples include Coco-Betaine (R=coco alkyl), Lauryl Betaine (R=lauryl, C₁₂H₂₅), and Oleyl Betaine (R=oleyl, C₁₈H₃₅).
Alkyl hydroxysultaines of the formula:

[chemical structure]

where R═C₆-C₂₄ alkyl (saturated or unsaturated) or mixture thereof. Examples include Coco-Hydroxysultaine (R=coco alkyl) and Lauryl Hydroxysultaine (R=lauryl, C₁₂H₂₅).
Alkyl sultaines of the formula:

[chemical structure]

where R═C₆-C₂₄ alkyl (saturated or unsaturated) or mixture thereof. Examples include Lauryl Sultaine (R=lauryl, C₁₂H₂₅) and Coco-Sultaine (R=coco alkyl).
Alkylamidoalkyl betaines of the formula:

[chemical structure]

where RCO═C₆-C₂₄ acyl (saturated or unsaturated) or mixtures thereof and x=1—Examples include Cocamidoethyl Betaine (RCO=coco acyl, x=2), Cocamidopropyl Betaine (RCO=coco acyl, x=3), Lauramidopropyl Betaine (RCO=lauroyl, and x=3), Myristamidopropyl Betaine (RCO=myristoyl, and x=3), Soyamidopropyl Betaine (R=soy acyl, x=3), and Oleamidopropyl Betaine (RCO=oleoyl, and x=3).
Alkylamidoalkyl hydroxysultaines of the formula:

[chemical structure]

where RCO═C₆-C₂₄ acyl (saturated or unsaturated) or mixtures thereof. Examples include Cocamidopropyl Hydroxysultaine (RCO=coco acyl, x=3), Lauramidopropyl Hydroxysultaine (RCO=lauroyl, and x=3), Myristamidopropyl Hydroxysultaine (RCO=myristoyl, and x=3), and Oleamidopropyl Hydroxysultaine (RCO=oleoyl, and x=3).
Alkylamidoalkyl sultaines of the formula:

[chemical structure]

where RCO═C₆-C₂₄ acyl (saturated or unsaturated) or mixtures thereof. Examples include Cocamidopropyl Sultaine (RCO=coco acyl, x=3), Lauramidopropyl Sultaine (RCO=lauroyl, and x=3), Myristamidopropyl Sultaine (RCO=myristoyl, and x=3), Soyamidopropyl Betaine (RCO=soy acyl, x=3), and Oleamidopropyl Betaine (RCO=oleoyl, and x=3).
Alkyl phosphobetaines of the formula:

[chemical structure]

where R═C₆-C₂₄ alkyl (saturated or unsaturated) or mixtures thereof and M⁺=monovalent cation, such as Sodium Coco PG-Dimonium Chloride Phosphate, where R=coco alkyl and M⁺=Na⁺.
Phospholipids of the formula:

[chemical structure]

where R═C₆-C₂₄ alkyl (saturated or unsaturated) or mixtures thereof, x=1-3 or mixtures thereof, x+y=3, z=x, a=0 to 2, B═O⁻ or OM, A=Anion, and M=Cation (refer to U.S. Pat. Nos. 5,215,976; 5,286,719; 5,648,348; and 5,650,402), such as Sodium Coco PG-Dimonium Chloride Phosphate, where R=coco alkyl, x=2, B═O⁻, y=1, z=1, A=Cl⁻, a=1, and M=Na⁺.
Phospholipids of the formula:

[chemical structure]

where RCO═C₆-C₂₄ acyl (saturated or unsaturated) or mixtures thereof, n=1-4, x=1-3 or mixtures thereof, x+y=3, z=x, a=0 to 2, B═O⁻ or OM, A=anion, and M=cation (e.g, U.S. Pat. Nos. 5,215,976; 5,286,719; 5,648,348; and 5,650,402). Examples include Cocamidopropyl PG-Dimonium Chloride Phosphate (RCO=coco acyl, n=3, x=3, z=3, A=Cl⁻, B and M are absent, y=0, and a=0) and Myristamidopropyl PG-Dimonium Chloride Phosphate (RCO=myristoyl, n=3, x=3, z=3, A=Cl⁻, B and M are absent, y=0, and a=0).
Amphoacetates of the formula:

[chemical structure]

where RCO═C₆-C₂₄ acyl (saturated or unsaturated) or mixtures thereof and M⁺=monovalent cation. Examples include Sodium Lauroamphoacetate (RCO=lauroyl and M⁺=Na⁺) and Sodium Cocoamphoacetate (RCO=coco acyl and M⁺=Na⁺).
Amphodiacetates of the formula:

[chemical structure]

where RCO═C₆-C₂₄ acyl (saturated or unsaturated) or mixtures thereof and M⁺=monovalent cation. Examples include Disodium Lauroamphodiacetate (RCO=lauroyl and M=Na⁺) and Disodium Cocoamphodiacetate (RCO=coco acyl and M=Na⁺).
Amphopropionates of the formula:

[chemical structure]

where RCO═C₆-C₂₄ acyl (saturated or unsaturated) or mixtures thereof and M⁺=monovalent cation. Examples include Sodium Lauroamphopropionate (RCO=lauroyl and M⁺=Na⁺) and Sodium Cocoamphopropionate (RCO=coco acyl and M⁺=Na⁺).
Amphodipropionates of the formula:

[chemical structure]

where RCO═C₆-C₂₄ acyl (saturated or unsaturated) or mixtures thereof and M⁺=monovalent cation. Examples include Disodium Lauroamphodipropionate (RCO=lauroyl and M⁺=Na⁺) and Disodium Cocoamphodipropionate (RCO=coco acyl and M⁺=Na⁺).
Amphohydroxypropylsulfonates of the formula:

[chemical structure]

where RCO═C₆-C₂₄ acyl (saturated or unsaturated) or mixtures thereof and M⁺=monovalent cation, such as Sodium Lauroamphohydroxypropylsulfonate (RCO=lauroyl and M⁺=Na⁺) and Sodium Cocoamphohydroxypropylsulfonate (RCO=coco acyl and M⁺=Na⁺).
Amphohydroxyalkylphosphates of the formula:

[chemical structure]

where RCO═C₆-C₂₄ acyl (saturated or unsaturated) or mixtures thereof and M⁺=monovalent cation, such as Sodium Lauroampho PG-Acetate Phosphate (RCO=lauroyl and M⁺=Na⁺).
Alkyl amine oxides of the formula:

[chemical structure]

where R═C₆-C₂₄ alkyl (saturated or unsaturated) or mixtures thereof. Examples include Cocamine Oxide (R=coco alkyl) and Lauramine Oxide (RCO=lauryl).
Alkylamidoalkyl amine oxides of the formula:

[chemical structure]

where RCO═C₆-C₂₄ acyl (saturated or unsaturated) or mixtures thereof and x=1—Examples include Cocamidopropylamine Oxide (RCO=coco acyl, x=3) and Lauramidopropylamine Oxide (RCO=lauroyl, x=3); and combinations of two or more thereof, and the like.

According to certain preferred embodiments, the zwitterionic surfactant is selected from the group consisting of alkyl betaines, alkyl hydroxysultaines, alkylamidoalkyl betaines, alkylamidoalkyl hydroxysultaines, amphohydroxypropylsulfonates, and combinations of two or more thereof.

In certain preferred embodiments, the cleansing bars of the invention comprise, from greater than about 0 to less than about 10 weight percent of total zwitterionic surfactants based on total active amount of surfactant(s) in the total weight of composition. In certain more preferred embodiments, the cleansing bars of the invention comprise from about 0.1 to about 10 weight percent of total zwitterionic surfactants. In certain even more preferred embodiments, cleansing bars of the invention have from about 0.5 to about 7.5 weight percent total zwitterionic surfactants. In more preferred embodiments, formulas have from about 0.5 to about 5 weight percent total zwitterionic surfactants. In most preferred embodiments formulas have from about 1 to about 4 weight percent total zwitterionic surfactants.

According to certain embodiments of the invention, water may be included in the cleansing bar. The water may be indirectly added as a part of other ingredients or may be intentionally added to improve bar properties. According to one embodiment, the concentration of water in the cleansing bar is from about 1 percent to about 20 percent, preferably from about 2 percent to about 15 percent, more preferably from about 3 percent to about 12 percent, even more preferably from about 4 percent to about 10 percent.

According to certain embodiments of the invention, soap may be included in the cleansing bar. As used herein, the term “soap” shall include alkali (e.g. Na⁺ and K⁺) and alkaline earth (e.g. Mg²⁺ and Ca²⁺), ammonium, or triethanolamine salts of saturated and unsaturated C₆-C₂₄ fatty acids, i.e. alkyl monocarboxylate salts. However, in order to maintain a pH of the cleansing bar that is less than about 8, it is highly desirable, according to certain embodiments, to limit the amount of soap in the cleansing bar. In certain embodiments, the concentration of soap is less than about 10 percent, preferably less than about 5 percent, more preferably less than about 1 percent, and, in certain embodiments, free of soap.

Cleansing bars of the present invention may further include additional ingredients, including those found in conventional cleansing bars. Examples of additional ingredients include but are not limited to nonionic surfactants, hydrophilic binders, humectants, conditioning agents, opacifying agents, chelating agents, conditioning agents, fillers, exfoliants, preservatives, skin benefit agents, and fragrances. Where applicable, chemicals are specified according to their INCI Name. Additional information, including suppliers and trade names, can be found in the following which are herein incorporated by reference: the INCI monograph in the International Cosmetic Ingredient Dictionary and Handbook, 14^{th} Edition published by the Personal Care Products Council, Washington D.C. and M. Friedman, Chemistry, Formulation, and Performance of Syndet and Combo Bars, Chapter 5 in Soap Manufacturing Technology, L. Spitz, ed., AOCS Press: Urbana, Ill., 2009, pp 153-189.

Examples of suitable nonionic surfactants include, but are not limited to Alkyl polyglycosides, Polyglycerol esters, and Polyhydroxy fatty acid amides. Examples of suitable Alkyl polyglycosides include Lauryl Glucoside, Coco-glucoside, and Capryl/Lauryl Wheat Bran/Straw Glycosides. Examples of suitable Polyglycerol esters include Polyglyceryl-10 Laurate, Polyglyceryl-10 Oleate, Polyglyceryl-10 Stearate, and Polyglyceryl-6 Distearate. Examples of suitable Polyhydroxy fatty acid amides include. Lauroyl Methyl Glucamide. The nonionic surfactant may be present in an amount of from about 0 percent to about 30 percent, such as 0 percent to about 10 percent.

Examples of suitable hydrophilic binders include Polyethylene glycols (e.g. PEG-x, where x=DP of PEG and ranges from about 10 to about 800). Ethoxylated fatty alcohols (e.g. Steareth-100), and Fatty acid ethoxylates (e.g. PEG-100 Stearate). The hydrophilic binder may be present in an amount of from about 0 percent to about 60 percent, such as 0 percent to about 20 percent.

Examples of suitable humectants include polyols such as glycerin, propylene glycol, propanediol, 1,4-Butanediol, 1,3-Butanediol, 1,2-Butanediol, Hydroxyethyl Urea, Sorbitol, Sorbitan, Xylitol and Polyglycerols (e.g. Polyglycerin-z, where z=2-20). The humectant may be present in an amount of from about 0 percent to about 30 percent, such as 0 percent to about 10 percent.

Examples of suitable conditioning agents include cationic or amphoteric water-soluble polymers and proteins. Examples of suitable cationic or amphoteric water-soluble polymers include Polyquaterniums, such as Polyquaternium-7, -10, -39, or -67, Guar Hydroxypropyltrimonium Chloride, and Cassia Hydroxypropyltrimonium Chloride. Examples of suitable proteins include hydrolyzed proteins, such as Hydrolyzed Wheat Protein, quaternized proteins such as Hydroxypropyltrimonium Hydrolyzed Soy Protein, and acylated proteins such as Sodium Cocoyl Hydrolyzed Amaranth Protein. The conditioning agent may be present in an amount of from about 0 percent to about 5 percent, such as 0 percent to about 1 percent.

Examples of suitable chelating agents include Ethylenediamine tetraacetic acid (EDTA) and salts thereof, e.g. Tetrasodium EDTA; Tetrasodium Glutamate Diacetate; and Tetrasodium Iminodisuccinate. The chelating agent may be present in an amount of from about 0 percent to about 3 percent, such as from about 0 percent to about 1 percent.

Examples of suitable fillers include those which may also function as binders or to enhance the hardness or feel properties of the bar. Classes of suitable fillers include organic fillers such as Dextrin, Starch (e.g. Corn Starch, Mannitol, Wheat Flour) and inorganic fillers (e.g., Talc, Mica, aluminosilicate clays, Sodium Sulfate, carbonate salts, such as Calcium Carbonate, and phosphate salts such as Calcium Phosphate. Talc is a preferred filler. The filler may be present in an amount of from about 0 percent to about 60 percent.

Examples of suitable opacifying agents include colorants, including organic dyes, (e.g. Yellow 10 or Orange 4) and inorganic pigments (e.g. Iron Oxides or Ultramarines), in amounts suitable to produce visually appealing colors and/or optical effects. The opacifying agents may be present in an amount of from about 0 percent to about 2 percent, such as from about 0 to about 0.075 percent. Titanium dioxide is a preferred opacifying agent.

Examples of suitable exfoliants include polyethylene beads, corn meal, walnut shell powder, and Luffa Cylindrica Fruit fiber. The exfoliants may be present in an amount of from about 0 percent to about 2 percent.

Examples of suitable preservatives include parabens, quaternary ammonium species, phenoxyethanol, benzoates, DMDM hydantoin. The preservatives may be present in an amount from about 0 to about 1 percent or from about 0.05 percent to about 0.5 percent.

Examples of suitable skin benefit agents include those suitable for use at pH less than about 8 and may include anti-aging agents, antimicrobial agents, anti-acne agents and the like. One suitable class of skin benefit agents are antimicrobial agents including organic acids and salts thereof, such as Alpha hydroxy acids, e.g. Glycolic Acid, Lactic Acid; Beta hydroxy acids, e.g. Salicylic Acid; and citric acid. The antimicrobial agents may be present in an amount from about 0 percent to about 4 percent, such as from about 0 to about 2 percent.

In order to enhance mildness and other properties of the cleansing bar, the cleansing bars of the present invention have a pH of about 8 or less as determined by ASTM method E70-07 Standard Test Method for pH of Aqueous Solutions with the Glass Electrode. According to certain embodiments the cleansing bar has a pH from about 3 to about 8, preferably from about 4 to about 7, more preferably from about 4 to about 6. Cleansing bars of the present invention provide high foaming, particularly in comparison to comparable cleansing bars that do not include a SAC. According to certain embodiments, when tested according to the Cleansing Bar Foam Test detailed in this specification, cleansing bars of the present invention have a Maximum Foam Volume that is at least about 30% higher than their comparable cleansing bar without a SAC. According to certain other embodiments, cleansing bars of the present invention have a Maximum Foam Volume that is at least about 40% higher than their comparable cleansing bar without a SAC, preferably at least about 41% higher, more preferably at least about 45% higher, even more preferably at least about 50% higher, even more preferably at least about 55% higher, and even more preferably at least about 60% higher than their comparable cleansing bar without a SAC. As one skilled in the art would readily understand and as defined herein the “comparable cleansing bar without a SAC” for any cleansing bar of the present invention means a cleansing bar with the same ingredients as the subject cleansing bar except with the SAC removed (i.e. a cleansing bar that has 0% by weight of SAC and wherein the additional material (“q.s.”) to compensate for the omission of SAC is composed of equal proportions by weight of the other (non-SAC) ingredients in the cleansing bar.) For example, see cleansing bar Inventive Example E1 and its comparable cleansing bar without a SAC Comparative Example C1, and cleansing bar Inventive Example E2 and its comparable cleansing bar without a SAC, Comparative Example C2, as described below.

Cleansing bars of the present invention may be made by any of various methods. According to certain embodiments, an aqueous surfactant mixture is prepared by combining the hydrophobic binder, the non-soap anionic surfactant, the water soluble bar hardener, and water such that the mixture is rendered fluid, thereby permitting homogeneous mixing of the components. While the relative proportions of the hydrophobic binder, the non-soap anionic surfactant, the water soluble bar hardener, and water may be varied, typically substantially the entire formula amount of each of the hydrophobic binder and the non-soap anionic surfactant that are intended to be used in the final cleansing bar are used to prepare the aqueous surfactant mixture. According to certain embodiments only a portion of the total formula amount of and/or the water soluble bar hardener is used in preparation of the aqueous surfactant mixture. According to certain embodiments the aqueous surfactant mixture includes at least about 80%, preferably at least about 90% of combined non-soap anionic surfactant and hydrophobic binder, with the remainder consisting essentially of water soluble bar hardener and water. The amount of water in the aqueous surfactant mixture may be from about 0.25 percent to about 20 percent, preferably from about 0.5 percent to about 15 percent, more preferably from about 1 percent to about 15 percent, even more preferably from about 2 percent to about 15 percent, and even more preferably from about 3 percent to about 15 percent.

Typically these ingredients in the aqueous surfactant mixture are allowed to mix at an elevated temperature. According to certain embodiments of the invention, the aqueous surfactant mixture is heated to a temperature that is sufficient to render it fluid. The elevated temperature may be sufficient to melt at least the non-soap anionic surfactant and the hydrophobic binder. For example, the hydrophobic binder, the non-soap anionic surfactant, the water soluble bar hardener, and water may be mixed at a temperature of at least about 150° F.

Whereas polymers used in conventional cleansing bars often require a separate hydration step in which the polymer is added to water (absent surfactant), the inventors have found that the SAC may conveniently be added directly to the heated aqueous surfactant blend. As such, according to certain embodiments of the invention, a solid SAC is added to the heated aqueous surfactant blend and allowed to mix until uniform to form a heated surfactant/copolymer blend. The surfactant/copolymer blend may at this particular time have a doughy or viscous consistency.

Additional materials may be added into the heated surfactant/copolymer blend. According to certain embodiments, one or more of amphoteric surfactant, additional water soluble bar hardener, additional water, among other optional ingredients are added and permitted to mix until uniform. In certain embodiments, the heated aqueous surfactant blend, optionally having the one or more additional materials added thereto, mirrors (i.e., is substantially the same as) the intended chemical composition of the final cleansing bar.

According to certain embodiments, in order to maintain a pH of about 8 or less, the amount of soap added during the process of making the bar is less than about 10 percent on a weight basis immediately prior to forming the cleansing bar, and is preferably less than about 5 percent, more preferably less than about 2.5 percent, even more preferably less than about 1 percent, such as less than 0.1 percent soap. While the inventors recognize that it is possible that a certain amount of soap may form in situ, according to certain embodiments, the heated aqueous surfactant blend includes less than about 10 percent of soap, preferably less than about 5 percent soap, more preferably less than about 1 percent soap immediately prior to cooling, and, in certain embodiments, is free of soap.

Prior to forming the final solid cleansing bar, the heated surfactant/copolymer blend may be subject to additional conventional processing steps. For example, according to one embodiment, the heated surfactant/copolymer blend is flaked such as by contacting the surfactant/copolymer blend with a metal roller which has been chilled such as by circulating cold water within the roller. The resulting material may comprise discrete, flaky structures. This flaked surfactant/copolymer blend may then be mixed or “amalgamated,” such as at ambient temperature. This mixing may be performed just before, during, or just after certain additional additives are mixed into the flaked surfactant/copolymer blend. These optional additives include heat sensitive ingredients such as fragrance and exfoliants heated aqueous surfactant blend before, during, or after these additional conventional processing steps.

According to certain other embodiments, the (flaked) surfactant/copolymer blend is extruded (e.g., through an opening) to form an extruded surfactant mass. A cleansing bar is then formed by, for example, conventional processes such as cutting (e.g., with a blade) and/or stamping the extruded surfactant mass with a die to form the final bar shape. Whereas polymers used in conventional cleansing bars to allegedly improve performance tend to create mushy bars that are difficult to process with extrusion and/or stamping, the inventors have found that cleansing bars of the present invention and/or using the inventive processes are easily processed.

In certain embodiments, the compositions produced via the present invention are preferably used as or in personal care products for treating or cleansing at least a portion of the human body. Examples of certain preferred personal care products include various products suitable for application to the skin, hair, and/or vaginal region of the body, such as shampoos, hand, face, and/or body washes, bath additives, gels, lotions, creams, and the like. As discussed above, applicants have discovered unexpectedly that the instant methods provide personal care products having one or more of desirable properties such as foaming characteristics, reduced irritation, and/or improved manufacturability.

The present invention provides methods of treating and/or cleansing the human body comprising contacting at least a portion of the body with a composition of the present invention. Certain preferred methods comprising contacting mammalian skin, hair and/or vaginal region with a composition of the present invention to cleanse such region and/or treat such region for any of a variety of conditions including, but not limited to, acne, wrinkles, dermatitis, dryness, muscle pain, itch, and the like. In certain preferred embodiments, the contacting step comprises applying a composition of the present invention to human skin, hair or vaginal region.

The cleansing methods of the present invention may further comprise any of a variety of additional, optional steps associated conventionally with cleansing the skin including, for example, lathering, rinsing steps, and the like.

### EXAMPLES

The following tests are used in the instant methods and in the following Examples.

Cleansing Bar Foam Test:

Determination of foam generated by the cleansing bar is measured in accordance with the following Cleansing Bar Foam Test. Pellets of bar-form products are used to determine their foam generating properties upon dissolution and agitation according to the present invention. The Cleansing Bar Foam test is conducted as follows: a pellet is fabricated by compressing shavings of a cleansing bar form product into a cylindrical pellet shape mold at 5000 psi (approx. weight of each pellet is 0.65 grams). To determine the Maximum Foam Volume, a solution of hard water (100 ppm Ca²⁺) is prepared by dissolving calcium chloride into deionized water and added to the sample tank of a SITA R-2000 foam tester (commercially available from Future Digital Scientific, Co.; Bethpage, N.Y.). The test parameters are set to repeat three runs (series count=3) of 250 ml sample size (fill volume=250 ml) with thirteen stir cycles (stir count=17) for a 15 second stir time per cycle (stir time=15 seconds) with the rotor spinning at 1200 RPM (revolution=1200) at a temperature setting of 35° C.±2° C. After the initial cycle where only the Ca²⁺ solution is stirred, the pellet is added to the sample tank (i.e. at time=15 s). Foam volume data is collected at the end of each stir cycle (2-17) and the average and standard deviation of the three runs are determined. The Maximum Foam Volume is reported for each example as the value after the 16th stir cycle (240 seconds).

Transepithial Permeability (TEP) Assay:

Irritation to the eyes and/or skin expected for a given formulation is measured in accordance with the Invittox Protocol Number 86, the “Trans-epithelial Permeability (TEP) Assay” as set forth in Invittox Protocol Number 86 (May 1994), incorporated herein by reference. In general, the ocular and/or skin irritation potential of a product can be evaluated by determining its effect on the permeability of a cell layer, as assessed by the leakage of fluorescein through the layer. Monolayers of Madin-Darby canine kidney (MDCK) cells are grown to confluence on microporous inserts in a 24-well plate containing medium or assay buffer in the lower wells. Exposure of a layer of MDCK cells grown on a microporous membrane to a test sample is a model for the first event that occurs when an irritant comes in contact with the eye. In vivo, the outermost layers of the corneal epithelium form a selectively permeable barrier due to the presence of tight junctions between cells. On exposure to an irritant, the tight junctions separate, thereby removing the permeability barrier. Fluid is imbibed to the underlying layers of epithelium and to the stroma, causing the collagen lamellae to separate, resulting in opacity. The TEP assay measures the effect of an irritant on the breakdown of tight junctions between cells in a layer of MDCK cells grown on a microporous insert. Damage is evaluated spectrophotometrically, by measuring the amount of marker dye (sodium fluorescein) that leaks through the cell layer and microporous membrane to the lower well.

The irritation potential of a formulation is evaluated by measuring the damage to the permeability barrier in the cell monolayer following a 15 minute exposure to dilutions of the product. Barrier damage is assessed by the amount of sodium fluorescein that has leaked through to the lower well after 30 minutes, as determined spectrophotometrically. The fluorescein leakage is plotted against the concentration of test material to determine the EC₅₀ (the concentration of test material that causes 50% of maximum dye leakage, i.e., 50% damage to the permeability barrier). Higher scores are indicative of milder formulas.

Unless otherwise indicated, the amounts of ingredients in the Example and Comparative compositions listed in the tables are expressed in w/w % of ingredient based on the total composition.

### Example I

### Preparation of Cleansing Bars

Two cleansing bars, Inventive Example E1 and Comparative Example C1 (a cleansing bar comparable to Inventive Example E1, but without a SAC) were prepared in accord with the following procedure: Unless otherwise indicated, all materials were added in the weight percent amounts as indicated for each composition in Table 1. An appropriately sized vessel was preheated using a steam jacket. Stearic acid was added and mixed until the temperature was between 175° F. and 185° F. This temperature range was maintained after addition of each ingredient or premix to the batch. HOSATPON SCI-65C (a mixture of sodium cocoyl isethionate with stearic and coconut fatty acids) was gradually added and mixed until it achieved a uniform and paste-like consistency. HOSTAPON SI (a mixture of sodium isethionate and water) was added and mixing was continued, forming a heated aqueous surfactant blend. For Inventive Example E1, the sodium hydrolyzed potato starch dodecenylsuccinate (superhydrophilic amphiphilic copolymer in the form of a spray-dried, free flowing powder) was added to the aqueous surfactant blend and mixing was continued until uniform. CHEMBETAINE CAS (a mixture of cocoamidopropyl hydroxysultaine and water) was added and mixed until uniform. Salt and titanium dioxide were mixed into sufficient water to bring the target of total water concentration in the final cleansing bar to concentrations consistent with Table 1, below (4 to 10 percent). This premix of salt, titanium dioxide and water was added to the batch. The batch was mixed to uniform consistency for an additional ten minutes. The material was then flaked using a chilled roll flaker and pelletized using a screw extruder. Inventive Example E2 and Comparative Example C2 (a cleansing bar comparable to Inventive Example E2, but without a SAC) were prepared were made in a similar manner to Inventive Example E1 and Comparative Example C1 respectively, except that the zwitterionic surfactant, CHEMBETAINE CAS was omitted. Comparative Example, C3 was made in a manner similar to Inventive Example E1, except that rather than adding the sodium hydrolyzed potato starch dodecenylsuccinate (SAC), cetyl hydroxycellulose was hydrated with water and added to the heated surfactant blend.

The flake was added to an amalgamator, mixed with any additional additives and milled on a three roll mill until uniform. The milled material was extruded through a vacuum extrusion plodder until a smooth, uniform billet was produced. The billets were cut in the appropriate size and weight, then stamped into the final shape with a die and foot press.

The compositions are shown in Table 1, below:

TABLE 1

| | | | | Comparative | | Comparative | Comparative |
|---|---|---|---|---|---|---|---|
| | | | Example Ex1 | Example C1 | Example Ex2 | Example C2 | Example C3 |
| | | | Formula | Formula | Formula | Formula | Formula |
| | | Activity | Amount | Amount | Amount | Amount | Amount |
| Trade Name | INCI Name | (%) | (wt %) | (wt %) | (wt %) | (wt %) | (wt %) |
| Hostapon SCI- | Sodium Cocoyl Isethionate | 65 | 31.53 | 33.19 | 33.49 | 34.94 | 32.04 |
| 65 C | (and) | | | | | | |
| (Clariant) | Stearic Acid (and) Coconut | 30 | 16.72 | 17.60 | 17.76 | 18.53 | 16.99 |
| | Fatty Acid | | | | | | |
| Stearic Acid | Stearic Acid | 100 | 11.55 | 12.16 | 15.89 | 16.58 | 15.20 |
| Water | Water | 100 | Q.S to 100% | Q.S to 100% | Q.S to 100% | Q.S to 100% | Q.S to 100% |
| Structure PS- | Sodium Hydrolyzed Potato | 95 | 4.75 | 0.00 | 4.77 | 0.00 | 0.00 |
| 111 | Starch Dodecenylsuccinate | | | | | | |
| (AkzoNobel) | | | | | | | |
| Natrasol CS | Cetyl Hydroxyethylcellulose | 100 | 0.00 | 0.00 | 0.00 | 0.00 | 5.01 |
| Plus 330 | | | | | | | |
| (Ashland) | | | | | | | |
| Chembetaine | Cocamidopropyl | 44 | 2.09 | 2.50 | 0.00 | 0.00 | 2.29 |
| CAS | Hydroxysultaine | | | | | | |
| Hostapon SI | Sodium Isethionate | 57 | 1.11 | 1.16 | 1.14 | 1.19 | 1.04 |
| (Clariant) | | | | | | | |
| Sodium | Sodium Chloride | 100 | 0.53 | 0.56 | 0.12 | 0.57 | 0.11 |
| Chloride | | | | | | | |
| Titanium | Titanium Dioxide | 100 | 0.53 | 0.56 | 0.12 | 0.57 | 0.11 |
| Dioxide | | | | | | | |

The example cleansing bars as well as a commercially available cleansing bar marketed specifically for sensitive/baby skin, “DOVE Baby Sensitive Skin Baby Bar,” (Comparative Example C4) were tested for foam generation. DOVE Baby Sensitive Skin Baby Bar is available from Unilever Canada of Toronto, Ontario. DOVE Baby Sensitive Skin Baby Bar purports to have the following ingredients: sodium lauroyl isethionate, stearic acid, sodium tallowate (or) sodium palmitate, lauric acid, sodium isethionate, water, sodium stearate, cocoamidopropyl betaine, sodium cocoate (or) sodium palm kernelate, sodium chloride, tetrasodium EDTA, tetrasodium etidronate, maltrol, and titanium dioxide.

The foam volume and irritation to the eyes and/or skin were conducted using the Cleansing Bar Foam Test and Transepithial Permeability (TEP) Assay respectively, as described herein. The results are shown in Tables 1-2 and FIGS. 1-2.

TABLE 1
Cleansing Bar Foam Test: Foam Volume vs. Cycles
Inventive Example, E1 and Comparative Examples C1, C3 and C4

| | Inventive | | | | | | | |
|---|---|---|---|---|---|---|---|---|
| | Example, | | | | | | | |
| | E1 | | Comparative | | Comparative | | Comparative | |
| | | Std | Example, C1 | | Example, C4 | | Example, C3 | |
| Cycles | Avg | Dev | Avg | Std Dev | Avg | Std Dev | Avg | Std Dev |
| 1 | 0 | 0 | 0 | 0 | 0 | 0 | 0 | 0 |
| 2 | 42 | 6 | 5 | 2 | 19 | 6 | 4 | 1 |
| 3 | 75 | 12 | 21 | 5 | 39 | 5 | 22 | 2 |
| 4 | 100 | 5 | 39 | 6 | 61 | 9 | 38 | 4 |
| 5 | 137 | 4 | 60 | 6 | 70 | 4 | 48 | 5 |
| 6 | 179 | 9 | 84 | 6 | 76 | 8 | 57 | 1 |
| 7 | 241 | 4 | 111 | 10 | 86 | 9 | 70 | 3 |
| 8 | 317 | 2 | 139 | 7 | 94 | 10 | 73 | 8 |
| 9 | 401 | 7 | 175 | 7 | 100 | 4 | 82 | 6 |
| 10 | 484 | 7 | 218 | 4 | 107 | 4 | 87 | 2 |
| 11 | 577 | 12 | 265 | 9 | 112 | 7 | 90 | 3 |
| 12 | 722 | 14 | 319 | 5 | 123 | 8 | 102 | 7 |
| 13 | 789 | 4 | 374 | 9 | 136 | 7 | 113 | 3 |
| 14 | 798 | 3 | 434 | 6 | 152 | 9 | 127 | 8 |
| 15 | 808 | 13 | 498 | 7 | 174 | 10 | 140 | 5 |
| 16 | 810 | 11 | 574 | 4 | 205 | 7 | 157 | 7 |

TABLE 2
Cleansing Bar Foam Test: Foam Volume vs. Cycles
Inventive Example, E2 and Comparative Example C2

| | Inventive Example, E2 | | Comparative Example, C2 | |
|---|---|---|---|---|
| Cycles | Avg | Std Dev | Avg | Std Dev |
| 1 | 0 | 0 | 0 | 0 |
| 2 | 7 | 1 | 8 | 3 |
| 3 | 28 | 0 | 21 | 2 |
| 4 | 45 | 2 | 38 | 3 |
| 5 | 55 | 2 | 47 | 5 |
| 6 | 63 | 3 | 59 | 5 |
| 7 | 74 | 2 | 61 | 6 |
| 8 | 91 | 4 | 76 | 2 |
| 9 | 98 | 1 | 78 | 3 |
| 10 | 107 | 3 | 85 | 7 |
| 11 | 124 | 1 | 92 | 4 |
| 12 | 133 | 3 | 100 | 6 |
| 13 | 155 | 1 | 100 | 3 |
| 14 | 165 | 2 | 116 | 4 |
| 15 | 185 | 5 | 124 | 2 |
| 16 | 212 | 8 | 134 | 5 |

Applicants have discovered that when the inventive cleansing bar is prepared with SAC, foam performance is dramatically increased. To illustrate the improvement of foam performance in the inventive cleansing bars, Table 1 shows Foam Volume vs. time for Inventive Examples E1 and Comparative Examples C1, C3, and C4 (and FIG. 1 shows this same data in plot form). It is clear from the Figure that the inclusion of the SAC markedly improves foaming performance. For example the Maximum Foam Volume of Inventive Example E1 (810 mL) was 41% higher than that of Comparative Example C1 (574 mL). This difference is even greater, at cycle 13 (195 seconds) where Inventive Example E1 (789 mL) was 111% higher than that of Comparative Example C1 (374 mL). Even more dramatic, the Maximum Foam Volume of Inventive Example E1 was five times higher than that of Comparative Example C3 (157 mL).

Furthermore, the foaming performance of the inventive cleansing bar is dramatically better than leading commercial cleansing bar shown in Comparative Example C4. Maximum Foam Volume of Inventive Example E1 was nearly four times higher than that of Comparative Example C4 (205 mL).

Furthermore, Table 2 shows a similar dramatic increase in foam performance when the zwitterionic surfactant is omitted. Foam Volume vs. time for Inventive Examples E2 and Comparative Example C2 (and FIG. 2 shows this same data in plot form). The Maximum Foam Volume of Inventive Example E2 (212 mL) was 58% higher than that of Comparative Example C2 (134 mL).

Applicants have further discovered that when the inventive cleansing is prepared with SAC, the cleansing bars are much more mild. TEP was measured as described in the specification above. Inventive Example E1 had a TEP mean score of 2.79% (standard deviation of 0.97) as compared to Comparative Example C4, which had a TEP mean score of 0.94% (standard deviation of 0.23), indicating that the inventive sample was much more mild.

We claim:

1. A method of making a solid cleansing bar, comprising:
heating an aqueous surfactant mixture to render it fluid, wherein said aqueous surfactant mixture comprises
a hydrophobic binder,
a non-soap anionic surfactant,
a water soluble bar hardener; and
from about 0.25 percent to about 20 percent water;
adding a solid superhydrophilic-amphiphilic copolymer to the heated aqueous surfactant mixture to form a heated surfactant/copolymer blend;
extruding the heated surfactant blend to form an extruded surfactant mass;
forming a solid cleansing bar having a pH of about 8 or less.

2. The method of claim 1 wherein said forming of said cleansing bar comprises cutting or stamping said extruded surfactant mass.

3. The method of claim 1 further comprising flaking said heated surfactant/copolymer blend prior to said extruding.

4. The method of claim 1 wherein said heated surfactant blend comprises no more than about 10% soap immediately prior to said forming of said cleansing bar.

5. The method of claim 1 wherein said formed solid cleansing bar has from about 3 percent to about 12 percent of water.

6. The method of claim 1, wherein the superhydrophilic amphiphilic copolymer has a mole percent of amphiphilic repeat units that is less than about 10.

7. The method of claim 1, wherein the superhydrophilic amphiphilic copolymer has a mole percent of amphiphilic repeat units that is from about 5 to about 10.

8. The method of claim 1, wherein the superhydrophilic amphiphilic copolymer has weight average molecular weight that is from about 1000 to about 100,000.

9. The method of claim 1, wherein the superhydrophilic amphiphilic copolymer comprises a starch-based polysaccharide modified with a hydrophobic reagent having a weight average molecular weight that is less than about 200,000.

10. The method of claim 1, wherein the formed solid cleansing bar has a pH from about 4 to about 7.

11. The method of claim 1, further comprising adding a zwitterionic surfactant to the heated aqueous surfactant mixture.

12. The method of claim 1, wherein the formed solid cleansing bar comprises from about 30 percent to about 70 percent of the non-soap anionic surfactant.

13. The method of claim 1, wherein the non-soap anionic surfactant is an acyl isethionate.

14. The method of claim 1, wherein the formed solid cleansing bar comprises from about 5 percent to about 50 percent of the hydrophobic binder.

15. The method of claim 1, wherein the hydrophobic binder is selected from fatty acids, fatty alcohols, esters of alcohols with fatty acids, polyol esters, waxes, mixed glycerides, triglycerides, hydrogenated tri glycerides, hydrogenated metathesis products of unsaturated triglycerides, and combinations thereof.

16. The method of claim 1, wherein the formed solid cleansing bar comprises from about 0.25 percent to about 10 percent of the water-soluble bar hardener.

17. The method of claim 1, wherein the water-soluble bar hardener is selected from inorganic metal cation salts of organic or inorganic acids.

18. The method of claim 1, wherein the formed solid cleansing bar has a Maximum Foam Volume that is at least about 30% higher than its comparable cleansing bar without the superhydrophilic amphiphilic copolymer, as measured by the Cleansing Bar Foam Test.
